(19) United States
(12) Patent Application Publication
(10) Pub. No.: US 2026/0288101 A1
(43) Pub. Date: Sep. 24, 2026

(54) SYSTEMS AND METHODS FOR MONITORING THE CONDITION OF AN AIR FILTER AND OF AN HVAC SYSTEM

(71) Applicant: 3M INNOVATIVE PROPERTIES COMPANY, St. Paul, MN (US)

(72) Inventors: Saber Taghvaeeyan, Maple Grove, MN (US); Robert W. Shannon, Stillwater, MN (US); Deepti Pachauri, Minneapolis, MN (US); Brian L. Linzie, Stillwater, MN (US); Golshan Golnari, Maple Grove, MN (US); Mojtaba Kadkhodaie Elyaderani, St. Paul, MN (US); Nicolas A. Echeverri, Woodbury, MN (US)

(21) Appl. No.: 19/692,118

(22) Filed: May 29, 2026

Related U.S. Application Data
(63) Continuation of application No. 17/605,393, filed on Apr. 22, 2020, now abandoned.
(60) Provisional application No. 62/837,484, filed on Apr. 23, 2019.

(51) Int. Cl. G05B 19/042; F24F 11/39; F24F 11/58; F24F 11/63; G06V 10/82; F24F 11/38; F24F 11/46; F24F 11/49; F24F 11/64; G05B 15/02

(52) U.S. Cl. CPC G05B 19/042; F24F 11/39; F24F 11/58; F24F 11/63; G06V 10/82; F24F 11/38; F24F 11/46; F24F 11/49; F24F 11/64; G05B 15/02; G05B 2219/2614

(57) ABSTRACT

Systems and methods for monitoring the condition of an air filter installed in an HVAC system and for monitoring the condition of the HVAC system. The monitoring system includes a processing unit configured to receive data representative of at least a first temporal parameter of the HVAC system. The processing unit can process the data to obtain an indication of the condition of the air filter and can also process the data to obtain an indication of the condition of the HVAC system.

### BACKGROUND

Heating, ventilation, and air conditioning (HVAC) systems are commonly used to control temperature in the occupied spaces of buildings. With many HVAC systems, an air filter is conventionally employed. After a period of use, the filter media of the air filter may accumulate particulate matter to the point that the air filter may be replaced for optimum filtration performance.

### SUMMARY

In broad summary, herein are disclosed systems and methods for monitoring the condition of an air filter installed in an HVAC system and for monitoring the condition of the HVAC system, for example the condition of a temperature-control unit of the HVAC system. The monitoring system includes a processing unit configured to receive data representative of at least a first temporal parameter of the HVAC system. The processing unit is configured to process the data to obtain an indication of the condition of the air filter and is also configured to process the data to obtain an indication of the condition of the HVAC system, e.g. of the temperature-control unit. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary building unit, an HVAC system that services the building unit, and a monitoring system, shown in idealized, generic representation.

FIG. 2 is a side perspective view of an exemplary HVAC system for a building unit and a monitoring system, shown in idealized, generic representation.

FIG. 3 presents a data sample comprising first and second temporal parameters (pressure and temperature) as obtained by a sensing unit of a monitoring system.

FIG. 4 presents a two-dimensional cluster analysis of encoded data for an HVAC system.

FIG. 5 presents a two-dimensional cluster analysis of encoded data for another HVAC system.

FIG. 6 presents a comparison of an actual data sample, and a reconstructed data sample from an encoding/decoding operation, for a temporal parameter (pressure) of an HVAC system.

FIG. 7 presents a comparison of an actual data sample, and a reconstructed data sample from an encoding/decoding operation, for a temporal parameter (pressure) of another HVAC system.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. Although terms such as e.g. “first” and “second” may be used in this disclosure, it should be understood that those terms are used in their relative sense only unless otherwise noted. The term “configured to” and like terms is at least as restrictive as the term “adapted to”, and requires actual design intention to perform the specified function rather than mere capability of performing such a function.

### DETAILED DESCRIPTION

The present disclosure relates to systems and methods for monitoring the condition of an air filter in an HVAC system of a building unit and for monitoring the condition of that same HVAC system, e.g. for monitoring the condition of a temperature-control unit of the HVAC system. Although the term “HVAC” is used for convenience, it is emphasized that such a system need only be configured to be able to perform at least one of heating and cooling; the system need not necessarily be capable of performing both functions although many such HVAC systems will do so.

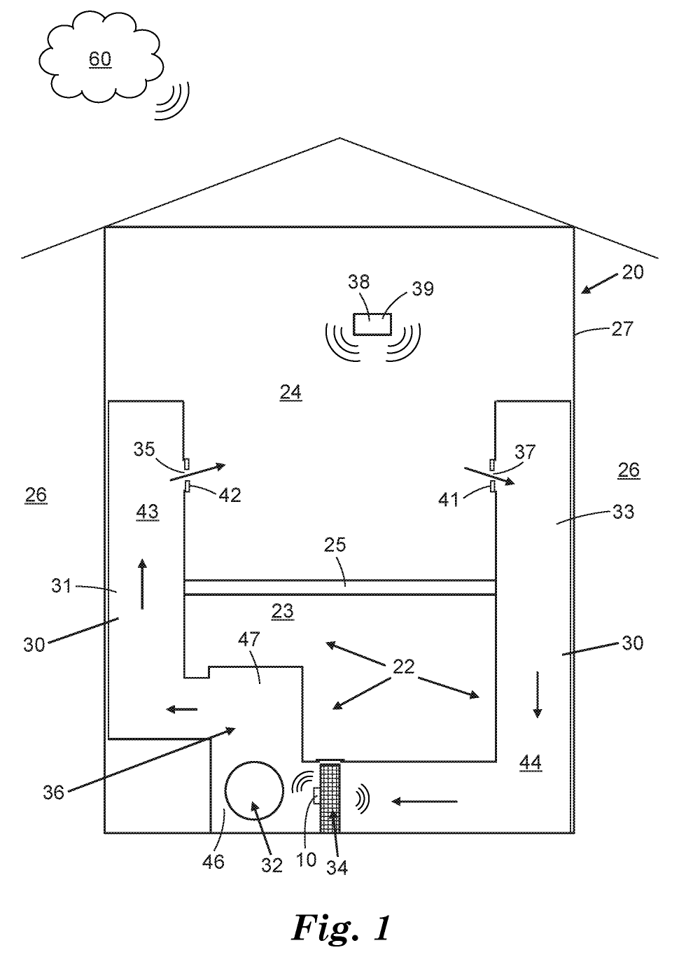

FIG. 1 schematically illustrates a building unit 20 having an installed HVAC system 22 (referenced generally). While building unit 20 is shown in FIG. 1 in the general form of a single-family dwelling (e.g. a residential house), it is emphasized that FIG. 1 is a generic, idealized representation for purposes of illustration. In general, a building unit 20 may be any enclosed structure or portion thereof, in which, for example, one or more persons live, temporarily reside, work, study, perform leisure activities, store belongings, and so on. A building unit 20 may be a single-family home (whether single-story or multi-story) or a duplex, triplex, townhouse or condominium that e.g. shares at least one wall with an adjoining unit. A building unit 20 may be a commercial or government enterprise (whether in a stand-alone building or occupying a portion of a building) such as a retail store, an office, a post office, and so on. It is thus understood that the term building unit is used for convenience to broadly denote any such entity, whether stand-alone or occupying a portion of a building.

At least a portion of the building unit 20 will be an occupied space 24 that is temperature-controlled by way of HVAC system 22 and that is thus supplied with temperature-controlled air by at least one air-delivery outlet as described below. In many instances, an occupied space 24 may take the form of multiple rooms. A building unit 20 will often comprise at least one exterior wall 27 that generally separates or isolates indoor air in occupied space 24 from outdoor air in an external environment 26.

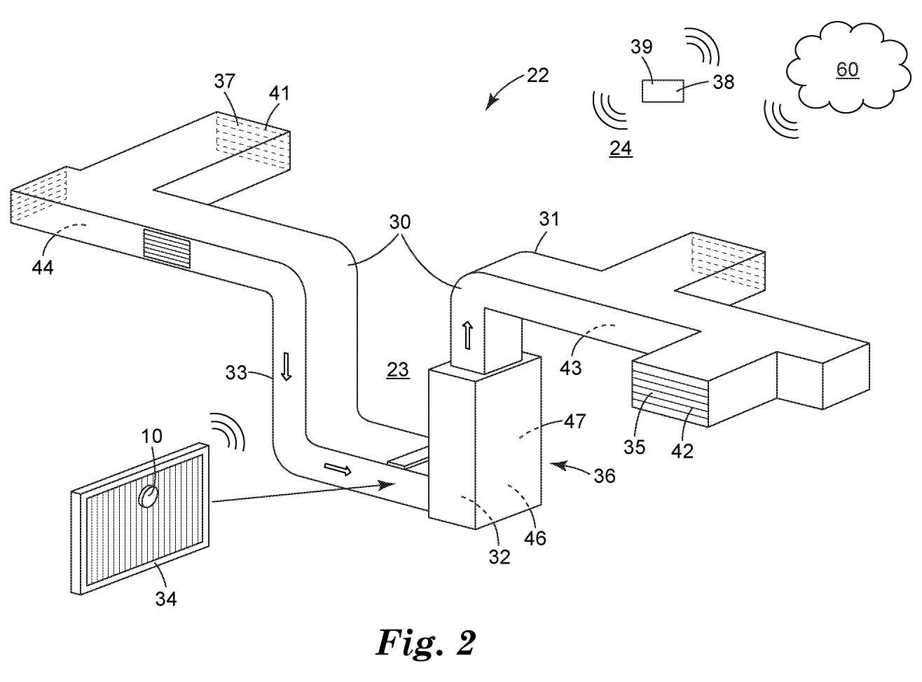

Many such building units comprise an HVAC system, i.e. a forced-air system that serves to heat and/or to cool the indoor air in occupied space 24. As indicated in exemplary manner in FIGS. 1 and 2, such an HVAC system 22 often relies on a heating and/or cooling unit 36. Such a unit, if used for heating, may comprise a combustion furnace operating on e.g. natural gas, propane or fuel oil; or it may include an electrical heater, a heat pump, a heat-exchange unit (relying on e.g. steam or hot water), and so on. Such a unit, if used for cooling, may comprise evaporator coils connected to an external condensing unit and whose operation will be well understood. Such a heating and/or cooling unit 36 will be referred to generically as a temperature-control unit; it will be understood that such terminology encompasses any unit that only heats, that only cools, or that is capable of performing heating or cooling as desired. Such a unit 36 may comprise a blower fan 32 located in a fan compartment 46, and a heat exchange compartment 47 containing e.g. heat exchangers and/or electrical resistance heaters, and/or containing evaporator coils.

HVAC system 22 further comprises ducting 30 that includes air-delivery ducting 31 via which temperature-controlled air (e.g. heated or cooled air) is delivered, as motivated by fan 32, into occupied space 24. Conventionally, this is done by equipping air-delivery ducting 31 with one or more air-delivery outlets 35, which are often fitted into an opening in a wall of an occupied space, and which are often fitted with registers 42. Ducting 30 often further comprises air-return ducting 33 via which air is returned to temperature-control unit 36 from occupied space 24. (Delivery and return of air are indicated by the various arrows in FIG. 1 and 2.) Conventionally, one or more air-return inlets 37 are provided for this purpose, which are often fitted into an opening in a wall of an occupied space and are often fitted with grilles 41.

As shown in exemplary embodiment in FIG. 2, air-delivery ducting 31 of an HVAC system 22 often comprises a main air-delivery plenum or trunk that receives air exiting temperature-control unit 36 and that may split into several air-delivery ducts that distribute the air to different rooms of the occupied space of the building unit. Any such air-delivery ducting 31, regardless of the particular configuration, will define an interior passage 43 through which temperature-controlled air passes to be delivered to occupied space 24. Similarly, air-return ducting 33 often comprises several air-return ducts that join into a main air-return trunk or plenum from which fan 32 pulls air into temperature-control unit 36. Any such air-return ducting 33, regardless of the particular configuration, will define an interior passage 44 through which air collected from occupied space 24 is returned to temperature-control unit 36. It will be appreciated that many modern temperature-control units utilize a fan (e.g. a variable speed fan) that may continue to run, e.g. at a lower speed, even when the temperature-control unit is not actively heating or cooling. Thus, the concept of air-delivery ducting does not necessarily require that the air that is delivered therethrough, must necessarily be temperature-controlled at all times.

In many instances, temperature-control unit 36 and at least a portion of ducting 30 (e.g. at least portions of air-return ducting 33 and air-delivery ducting 31) are located in a machinery space 23, as indicated in exemplary embodiment in FIG. 1. In many instances such a machinery space 23 is not a part of an occupied space 24. Rather, in some instances a machinery space 23 may be located in a basement or crawl space of a building unit and may often be separated from an occupied space 24 by at least one floor 25 and/or at least one wall. It will be understood that FIG. 1 is a simplified representation for purposes of illustration and that in actuality a wide variety of configurations of occupied spaces and machinery spaces, are found. Such variations notwithstanding, in many instances a temperature-control unit of an HVAC system may be located in a part of a building that is relatively remote from the occupied spaces of the building, is not frequently visited by occupants of the building, and so on.

An HVAC system typically comprises one or more thermostats or similar controllers that dictate operation of the HVAC system 22, such as by activating fan 32 and/or other components of temperature-control unit 36 (e.g. a gas-fed furnace) in response to various conditions, such as sensed indoor temperature.

One or more air filters 34 are typically provided in order to filter the air that passes through HVAC system 22. In some embodiments, such an air filter is one in which at least the filter media thereof is disposable or recyclable rather than the filter being permanently installed and/or cleanable. In some instances, an entire filter, including a perimeter support frame thereof, is recyclable. In other embodiments, the frame or other support may be reusable with a fresh air filter media installed thereinto.

Such an air filter serves a basic purpose of minimizing the number of airborne debris (e.g. hair, carpet fibers, clothing lint, and so on) that reaches temperature-control unit 36. As such, an air filter 34 is often installed in the main air-return trunk of air-return ducting 33, upstream of temperature-control unit 36, typically at a location fairly close to (e.g. within a meter of) temperature-control unit 36. However, in recent years, such air filters 34 have been engineered to not only protect temperature-control unit 36 from airborne debris, but to also remove undesired materials (e.g. fine particles such as dust, pollen, pet dander, and so on) from the air. Thus, monitoring the condition of such air filters has become increasingly important. In particular, the amount of particulate matter that has accumulated in the filter media has become an increasingly useful parameter to monitor since the continued accumulation of particulate matter in the filter media may affect the filtration performance (as manifested e.g. in the ability of the filter to process a particular volumetric flowrate of air to a particular filtration efficiency).

The herein-disclosed monitoring system comprises at least one sensing unit 10 as shown in exemplary manner in FIGS. 1 and 2. The monitoring system and sensing unit thereof serve a first function of monitoring the condition of an air filter of the HVAC system. The monitoring of the condition of an air filter is achieved by monitoring (whether e.g. continuously or intermittently) at least one parameter that is indicative of the amount of particulate matter accumulated in the filtration media of the air filter. The term condition of an air filter broadly encompasses e.g. an estimate of the current filtration performance (according to any representative indicator), an estimate of a current or impending need for replacement of the filter, an estimate of the remaining usable filter life (regardless of how close the filter is to the end of its estimated usable filter life), and so on. A report of the condition of an air filter may be presented in any suitable manner, whether in terms of any of the above-listed phrasings or in other terms or ways.

The herein-disclosed monitoring system and sensing unit thereof further serves a second function of monitoring the condition of the HVAC system itself, e.g. the condition of a temperature-control unit of the HVAC system. As discussed later herein in detail, this second function is separate from the above-described first function. Discussions herein will make it clear that the monitoring of the condition of the HVAC system does not necessarily provide an indication of the amount of particulate matter accumulated in the air filter. In fact, in many instances a condition of the HVAC system, as monitored and reported by a herein-disclosed system, may not necessarily be correlated with any particular condition of the air filter.

The systems and methods disclosed herein rely on a sensing unit that can be easily added to an existing HVAC system or otherwise used in conjunction with an existing HVAC system e.g. by way of the sensing unit being mounted on an air filter that is installed into the HVAC system. Thus, these systems and methods do not require the use of a sensing unit that is pre-installed in the HVAC system e.g. when the HVAC system is installed in the dwelling.

As disclosed herein, a sensing unit 10 is provided that, as a first function, allows the condition of air filter 34 to be monitored. In some convenient embodiments such a sensing unit may be provided with, e.g. mounted on or otherwise attached to, the air filter (e.g. to the filter media and/or a frame if present) that the sensing unit is used to monitor. In many embodiments, the sensing unit 10 may be the only such sensing unit comprised by the herein-disclosed monitoring system. In other words, in at least some embodiments the sensing unit will be a sole sensing unit and will thus distinguish the presently-disclosed monitoring system from, for example, monitoring systems that rely on an array of multiple sensing units that are installed in different physical locations of an HVAC system.

However, as will be evident from the discussions that follow, such a single, e.g. filter-mounted, sensing unit 10 may itself comprise multiple sensors and/or sensing elements, e.g. located on or within a housing of the single sensing unit. It is also noted that the terminology of a single sensing unit allows the presence of other sensing units that are associated with the HVAC system but that are not part of the presently disclosed monitoring system. For example, many temperature-control units, e.g. furnaces, may comprise various sensing units to facilitate efficient operation of the unit.

In some embodiments, a filter-mounted sensing unit 10 may be provided as a companion to an air filter that is installed into the HVAC system and may be removed along with that air filter e.g. at the end of the usable life of the air filter, with a new air filter and sensing unit then being installed. In other embodiments, such a sensing unit may be re-used, e.g. it may be removed from a spent air filter and installed on a replacement air filter. In some embodiments, a sensing unit 10 may not necessarily be filter-mounted as long as it is installed in the HVAC system at a location at which it can perform the functions disclosed herein. For example, a sensing unit might be mounted to the inside wall of a duct, e.g. downstream of the air filter between the air filter and a temperature control unit of the HVAC system.

### Monitoring of temporal parameter

Sensing unit 10 may comprise any suitable sensor or sensors, that monitor any temporal parameter or parameters of the HVAC system, and that function by any suitable mechanism. By a temporal parameter is meant a parameter that is capable of varying over time (although it may go for some stretches of time without varying significantly) in response to the operation of the HVAC system. In many embodiments, such a temporal parameter may be pressure, e.g. pressure of the return air at a location proximate the air filter of the HVAC system, as discussed below. In some embodiments such a temporal parameter may be temperature, e.g. temperature of the return air at a location proximate the air filter of the HVAC system, also as discussed in detail herein. However, any parameter that varies with time and with the operation and condition of the HVAC system may be used, including but not limited to, humidity, air velocity, the amount of particulate matter in the air, and so on. In some embodiments, the monitoring system may obtain and utilize data that is representative of multiple (e.g. two, three or more) temporal parameters.

Although terms such as e.g. pressure sensor or temperature sensor may be used herein for convenience, it is emphasized that in some embodiments it may not be necessary that the sensing unit (or the processing unit) ever obtains, calculates, stores, or otherwise handles an actual, specific value of the temporal parameter in question. Rather, all that is needed is that the data be in a form that is representative of the parameter in question. For example, a pressure-sensing element of a sensor may output a signal in the form of e.g. a voltage; the signal may be processed, transmitted and/or otherwise manipulated in that form, or in any form derived therefrom (e.g. it may be subjected to analog-digital conversion), without necessarily obtaining an actual value of the pressure. All that is necessary is that the data be representative of the chosen temporal parameter so that the data allows the extraction of information as needed to perform the desired monitoring.

In some embodiments, a sensing unit 10 may comprise a pressure sensor. By a pressure sensor is meant a sensor that includes at least one pressure-sensitive element (e.g. a piezoresistive element, a capacitive element, an electromagnetic element, a piezoelectric element, an optical element, or the like). In some embodiments, such a sensing unit may be located downstream of air filter 34 (i.e., between air filter 34 and fan 32 of unit 36). For example, the sensing unit may be mounted on the downstream side of the air filter. Such a sensing unit can monitor the pressure (partial vacuum) that is established by fan 32 in the act of drawing air through air filter 34. Monitoring of this pressure over time can allow the amount of particulate matter that has accumulated in the filter media of air filter 34 to be estimated and can thus be used to provide an indication of the remaining usable filter life. Possible configurations and arrangements and methods of using sensing units of this general type are described in detail in U.S. Patent 10,363,509, which is incorporated by reference in its entirety herein. Possible arrangements and methods are also described in the published (PCT) patent application designated as International Publication No. 2018/031403; and, in the resulting U.S. national stage (371) patent US 9,963,675, both entitled Air Filter Condition Sensing and both of which are incorporated by reference in their entirety herein. In some embodiments a pressure sensor may be the only sensor present on the sensing unit. In other embodiments at least one additional sensor, e.g. a temperature sensor, may be present as well.

In some embodiments a sensing unit 10 may comprise a temperature sensor. By a temperature sensor is meant a sensor that includes at least one temperature-sensing element (e.g. a solid-state temperature-sensitive element such as a silicon-bandgap diode; a thermistor; a thermocouple, or the like). In some embodiments a temperature sensor may be the only sensor present on the sensing unit. In other embodiments the temperature sensor may be present in addition to e.g. a pressure sensor as noted above.

Regardless of the particular temporal parameter and the mechanism by which it is sensed, any such sensor, and sensing unit 10 as a whole, will comprise associated circuitry as needed to operate the sensing element. In various embodiments, such circuitry may be configured to do any or all of: recording data, treating data to put it in a form more easily handled by a remote processing unit, transmitting data to a remote processing unit, receiving instructions (e.g. instructions to clear any previously-stored data), and so on. The sensing unit will also comprise any other mechanical component(s), hardware, software, and so on, as needed to allow the sensing unit to function. For example, the sensing unit may comprise an internal power source, e.g. a battery. The sensing unit may comprise a housing (e.g. a molded plastic housing) that provides mechanical integrity and protection for the various components; such a housing may of course comprise any needed openings or the like to allow the one or more sensors to function properly. If desired, the housing may comprise one or more connectors or other attachment mechanisms to allow the sensing unit to be mounted to an air filter. In various embodiments the sensing unit may comprise a wireless transmitter as discussed below, may comprise on-board data storage so that the data that is obtained can be stored on-board the sensing unit until such time as it can be wirelessly transmitted to a remote processing unit, and so on.

### Processing unit

In at least some embodiments, it may be convenient for such a sensing unit 10 to be able to wirelessly communicate with a local device 38 in order to perform the desired monitoring functions. By a “local” device is meant a device that is located, or can be taken, within direct wireless communication range (e.g. via Bluetooth) of sensing unit 10. In some embodiments such a local device may be a mobile device (e.g. a smartphone, a tablet computer, laptop computer, or the like). Alternatively, such a local device may be a non-mobile device (e.g. a desktop computer, a router, or the like).

Whatever the specific arrangement, in some embodiments sensing unit 10 will transmit data, directly or indirectly, to a remote processing unit so that the remote processing unit can use the data to obtain an indication of the condition of the air filter of the HVAC system; and, to obtain an indication of the condition of the HVAC system, e.g. of the condition of the temperature-control unit of the HVAC system. In some embodiments, such a remote processing unit can include, or take the form of, a software program (e.g. an app) 39 residing on a local device (e.g. a mobile device 38) that is associated with a user of the HVAC system. In some embodiments the remote processing unit may be resident on the local device and may be configured so that the data can be processed on the local device without being forwarded e.g. to a cloud-based server. (Alternatively, the remote processing unit may be loaded on a non-mobile device that is e.g. located within direct wireless communication range of the sensing unit.) Any such processing unit that is not on-board sensing unit 10 itself, qualifies as a remote processing unit as defined below.

In some embodiments a local-device-resident app or similar program may instruct the local device to forward the data to a cloud-based server 60 on which the remote processing unit is resident. (It will thus be understood that the term “local” distinguishes an entity from a cloud-resident entity; a local entity, not being on-board the sensor, will thus qualify as a remote entity as noted above.) The data can then be processed to obtain one or both of the above-listed indications. The cloud-based remote processing unit may then transmit the obtained indication(s) to the local device which (e.g. via a local device-resident app) reports the condition of the air filter and/or of the HVAC system to a user. As used herein, the term “user” broadly encompasses e.g. a resident, homeowner, manager of a commercial establishment, HVAC technician, or other person that is concerned with the status of the HVAC system. The user will not necessarily be the owner of the HVAC system and/or a mobile device that is used to report the status of the HVAC system.

Thus in some embodiments, a remote processing unit may be resident on a mobile device (e.g., mobile smart phone, tablet computer, personal digital assistant (PDA), laptop computer, smart speaker, smart TV, intelligent personal assistant, media player, etc.). In other embodiments, a remote processing unit may be resident on a non-mobile device (desktop computer, computer network server, cloud server, etc.). Thus, as alluded to above, by “remote” is meant that the processing unit is not physically connected to the sensing unit 10 and must communicate wirelessly with the sensing unit as discussed herein. Such wireless communication may be conveniently facilitated by way of, for example, a Bluetooth or Low Energy Bluetooth radio broadcaster/receiver present on sensing unit 10.

In some embodiments the data can be transmitted along a portion of its path through cellular towers and/or through electrical wires or fiber optical cables. For example, a wireless signal from a sensing unit 10 may be received by a mobile device which then forwards the signal to a remote processing unit on a cloud-based server, through a cellular network and/or through electrical wiring and/or fiber optical cables. It will thus be understood that “wireless” communication, “wireless” transmission and like terminology, requires only that at least a portion of the total signal path from the sensor to the remote processing unit (e.g. at least an initial portion originating from the sensor) must be wireless.

Data received by the processing unit will be processed to obtain an indication of the condition of the air filter; data received by the processing unit will also be processed to obtain an indication of the condition of the HVAC system (e.g. of the temperature-control unit of the HVAC system). Any such processing unit may rely on one or more processors configured to operate according to executable instructions (i.e., program code), in combination with memory and any other circuitry and ancillary components as needed for functioning, as will be discussed in further detail later herein.

In various embodiments, any or all of the above-described operations (e.g., obtaining of data by the sensing unit, transmission of data to a processing unit, processing of the data, etc.), may occur without any need for action on the part of the user. Indeed, in many embodiments they may occur without the user needing to be aware that the operations are occurring, depending e.g. on how the user chooses to configure the monitoring system.

In at least some embodiments, the systems and methods of the present disclosure include reporting an air filter condition; and, reporting the condition of an HVAC system, e.g. a temperature-control unit thereof, to a user. This can be done by providing the processing unit with any suitable reporting module that is associated with the processing unit in any suitable manner. For example, a processing unit that is resident on a mobile device may report a condition. However, an arrangement in which, for example, a processing unit on a cloud-based server provides an indication to e.g. a mobile device causing the mobile device to report a condition, likewise falls within the herein-disclosed concept of a processing unit that is configured to report a condition to a user.

Such a report may take any suitable form. In various embodiments, such a report may comprise a communication (which may be a text string, and/or may include any suitable graphical symbols or representation) in the form of an email, a text message, and so on, to any device selected by the user. As noted earlier herein, if a report includes text, any suitable phrasing may be used. For example, a report regarding the filter condition may be phrased e.g. in terms of the estimated remaining filter life, the estimated current filtration performance, or in any other suitable manner.

In some embodiments, such a report may be actively provided to a user as a “push” notification that is triggered automatically by the processing unit without requiring any action by the user. However, if desired, the processing unit can be configured so that a condition report can be provided to the user upon request, e.g. in response to a status inquiry that is input into the system (e.g. by way of an app on a mobile device) by the user. This functionality may be in addition to, or in place of, a “push” reporting functionality.

Exemplary arrangements and methods by which a sensing unit may be configured to communicate with a mobile device and/or with a remote processing unit (in particular, arrangements involving the use of geofencing, although this is not necessarily required for the present monitoring system) are described in detail in U.S. Provisional Patent Application No. 62/781830, which is incorporated by reference in its entirety herein. For brevity, the above discussions do not discuss details of the processes of activating a newly-obtained sensing unit, pairing the sensing unit with an app, and so on. Such topics are discussed in detail various of the patent applications previously mentioned (and incorporated by reference) herein, which are referred to for this purpose. Although discussions herein have primarily concerned the use of Bluetooth (e.g. Bluetooth Low Energy) wireless communication, it will be appreciated that any suitable WPAN communication method or protocol (e.g. IrDA, Wireless USB, Bluetooth, or ZigBee) may be used.

It is emphasized that the arrangements herein do not necessarily require that communication of sensing unit 10 with a remote processing unit must be performed by way of a mobile device (e.g. a smartphone) being taken into direct wireless communication range of sensing unit 10. Rather, as noted, in some embodiments such communication may take place e.g. by way of sensing unit 10 wirelessly communicating with a local entity that is non-mobile (e.g. a router, a desktop computer serving as a hotspot, and so on) and that can forward the data to the remote processing unit. Thus, in at least some embodiments it is not necessary for a user to bring a mobile device within direct wireless communication range of sensing unit 10 in order for the monitoring system to perform its function. This can provide that, for example, the monitoring system can still function, and a user can still receive reports of the condition of the air filter and/or the temperature-control unit of the HVAC system, even if the user is far away from the HVAC system (e.g., is away on vacation). It will thus be appreciated that in some embodiments, a mobile device may act as a relay to forward data from a sensing unit to a cloud-based server; in such embodiments the mobile device may or may not serve as a means by which a report is issued to an end user. In other embodiments, a mobile device may not act as a relay to forward data to a cloud-based server, but may nevertheless serve as a means by which a report is issued. It will be appreciated that numerous variations are possible.

In various embodiments a report (notification) may be provided to a user that is e.g. a homeowner, renter, site manager, custodian, building engineer, or, in general, any person who is concerned with the condition of the HVAC system in question. As noted, in some convenient embodiments such a report may be delivered to a mobile device associated with the person. However, in some embodiments, such a report (in fact, multiple reports from sensing units located on different HVAC systems in different locations) may be sent to a central monitoring location (or to a mobile device that is configured to receive reports from multiple sensing units). In some such embodiments an HVAC servicing and maintenance company may be tasked with monitoring the condition of multiple HVAC systems and may e.g. dispatch a service call in the event of a potential problem being identified on one such HVAC system.

The discussions above have primarily concerned how a sensing unit 10 can obtain temporal data and how a processing unit can process that data to obtain an indication of the condition of an air filter of an HVAC system. It has now been appreciated that, as enabled by the arrangements disclosed herein, the temporal data can be used for at least one additional purpose. Specifically, it has been found that if temporal data obtained by a sensing unit is subjected to a pattern recognition operation performed by a processing unit, in some instances patterns may be identified that can indicate a possible condition of the HVAC system, e.g. of a temperature-control unit of the HVAC system. In other words, the arrangements disclosed herein can provide a monitoring system that, in addition to reporting on the condition of an air filter that is installed in an HVAC system, can also report e.g. on the condition of a furnace and/or air conditioner of the HVAC system. The term pattern recognition broadly encompasses any process concerned with the automatic discovery of regularities in data through the use of software-resident algorithms and with the use of these regularities to take actions such as classifying the data into different categories, in accordance with the meaning of pattern recognition as it would be broadly understood by artisans in the field. The processing unit may of course perform any data manipulation that may enhance the ability to perform pattern recognition on the data.

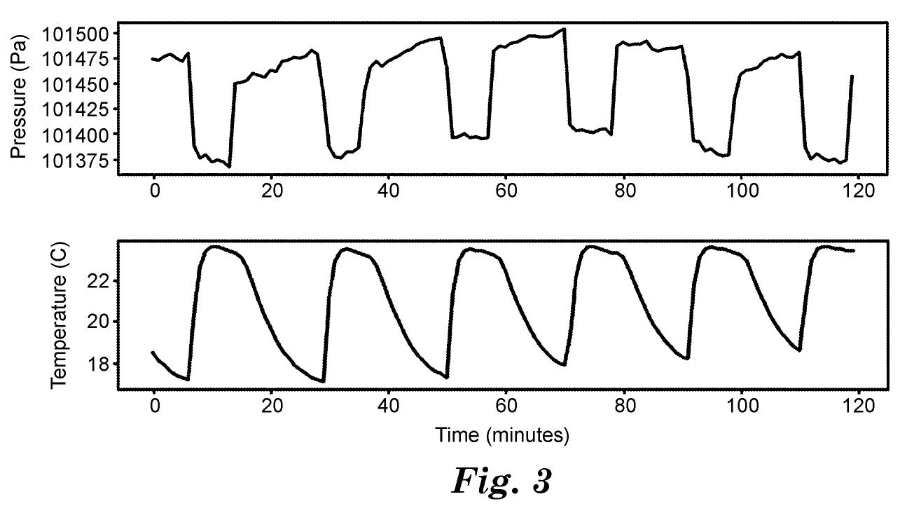

For example, in some embodiments a sensing unit may obtain temporal data in the form of pressure data, as exemplified in FIG. 3. (As discussed in further detail in the Working Examples herein, FIG. 3 presents an actual data sample obtained in the field, by a sensing unit installed on an air filter of an HVAC system of a building unit.) It is evident from FIG. 3 that the sensing unit was able to track the rising and falling pressure corresponding to the cycling on and off of a blower fan of the temperature-control unit. The same sensing unit obtained additional temporal data in the form of temperature data also as shown in FIG. 3. It is evident that the sensor was able to track the rising and falling temperature of the return-air (which would be expected to track the temperature of the air in the occupied space of the building unit).

The present work has shown that such data can be used to obtain an indication of the condition of the HVAC system, e.g. the condition of the temperature-control unit of the HVAC system. In some embodiments, the processing unit can process the data by performing a pattern recognition operation with the data in an unreduced form. By unreduced data is meant data that has not been subjected to a dimensionality reduction (e.g. encoding) process of the type discussed later herein. In some embodiments unreduced data on which a pattern recognition operation is performed, may be “raw” data as obtained and/or transmitted by the sensing unit to the processing unit. However, in other embodiments the sensor-obtained data may (e.g. while remaining in unreduced form), be e.g. filtered, smoothed, processed to put the data into a form in which it can be wirelessly transmitted with minimum power consumption, and so on.

Those of ordinary skill in the art of pattern recognition methods will readily appreciate from the disclosures herein that patterns may be discerned from time-pressure data of the type presented in FIG. 3, and/or from time-temperature data of the type presented in FIG. 3. For example, a pattern recognition operation could derive an apparent cycling frequency from the patterns shown in these Figures. The processing unit could compare this frequency to a nominal (expected) cycling frequency of a temperature-control unit and could thus, for example, report whether the particular temperature-control unit appeared to be short-cycling (that is, turning on and off at an uncharacteristically high frequency that might be indicative of an issue or problem). It is emphasized that this is merely a specific example and that many other types of analyses, of greater complexity or sophistication, may be applied to such data.

Any such analysis may be applied to any suitable temporal parameter, e.g. temperature or pressure. In some embodiments two such temporal parameters may be analyzed independently e.g. with the results of one analysis being used to cross-check or verify the results of the other analysis. However, in many useful embodiments two (or more) such parameters may be co-analyzed, i.e. examined in combination so that relationships between the parameters may be used to extract useful information regarding the performance of the HVAC system. (This applies to unreduced data as well as to dimensionally-reduced data as discussed below.) In a simple example, pressure and temperature data may be analyzed in combination to discover whether a temperature rise or fall corresponds to a pressure rise or drop to understand whether the temperature-control unit was actively heating, or cooling, during the period in question, e.g. in order to evaluate whether a potential issue appears to be with a heating function or with a cooling function, of the temperature-control unit.

The arrangements disclosed herein allow separate, e.g. parallel, processing operations to be performed on the same data; that is, a first process for the purpose of providing an indication of the remaining filter life and a second process for the purpose of revealing any possible issues with e.g. a temperature-control unit of the HVAC system. The designation of first and second is for convenience and does not imply that the second process must be performed after the first process or that the second process must use data outputted by the first process. Rather, these will typically be separate, independent processes. Depending on how the monitoring system is configured, the first process may be performed at certain times or on a certain schedule, with the second process being performed at other times or on a different schedule. Also, by the same data does not mean that the data as handled in the second process must be the exact same data set, and/or that the data must be in the same exact form, as the data as handled in the first process. For example, a first process may only need to use a subset of the data as would be used in a second process, or vice versa. Rather, the same overall data set or stream is able to be used for multiple purposes.

### Dimensionally-reduced data

The discussions above make it clear that in some embodiments an indication of the condition of an HVAC system, e.g. of a temperature-control unit thereof, may be obtained by working with unreduced data. Such data may be analyzed by a pattern recognition process of any suitable type. In some embodiments, such a process could be any one of various pattern recognition operations that are often referred to as classical (e.g. non-neural network) methods of data analysis. Such methods might include e.g. expectation-maximization methods, “dictionary” learning, etc.

However, the present investigations have revealed that in at least some embodiments working with reduced-dimensionality data may allow some conditions (e.g. more subtle operating characteristics and behaviors) to be more easily and/or fully discerned from the data. Thus in some embodiments, the processing unit may be configured so that data as received (e.g. in the general form shown in FIG. 3) may be subjected to one or more processing steps in which the data is dimensionally reduced. In brief, dimensionality reduction is a process of reducing the number of variables under consideration by reducing a set of variables to a smaller (more dense) set of representative variables. Those of ordinary skill in the art of data analysis and pattern recognition will readily understand what is meant by dimensionality reduction of data and will be familiar with methods by which such processing can be carried out.

In some embodiments, the dimensionality reduction can be performed by an autoencoder. As will be understood by those of ordinary skill in the art, autoencoding involves dimensional reduction of data, performed by an encoding neural network to obtain a compressed, dense representation (i.e. an encoding) of the original data. The encoder part of an autoencoder is coupled with a decoding neural network that reconstructs the original data from the compressed version that was generated by the encoder network. The encoder part of an autoencoder may, for example, rely on layers of neural networks with one or more intermediate layers having a reduced number of nodes in comparison to one or more predecessor (and/or successor) layers, so that the autoencoder necessarily compresses the data. On the other hand, the decoder part of an autoencoder may rely on layers of neural networks having an increased number of nodes compared to the encoded representation and with the number of nodes of its final layer matching with the length of the original data. Whatever the specific configuration, an autoencoder will retain patterns in the compressed data that allow the original input data to be reconstructed by the decoder network (that is trained at the same time as with the encoding network e.g. to a desired degree of fidelity), while discarding superfluous data in order to achieve the desired compression. Autoencoders have found use in, for example, image recognition, content-based image retrieval, and similar applications.

An autoencoding operation will produce a set of dimensionally-reduced representative values that is smaller, e.g. far smaller, than the original data. By way of a simple example, a data sample that closely resembles a sine wave, even if comprising e.g. millions of individual data points, could be encoded by three representative values (amplitude, frequency, and phase) along with any functions or “rules” that the data sample follows (e.g., the formula for a sine wave). During a training phase, an autoencoder would learn this formula (or something similar) and how to condense a given input signal into the unique three representative values for that signal by “looking at” a training data set comprising many samples of different sine waves. When given a new signal (a test sample) it has never seen before, the autoencoder would now use what it has learned to condense the test sample down to three unique values. The original test sample can be reconstructed from these three values by applying the trained decoder network to the compressed representation; the degree to which the reconstructed test sample will match the original test sample will depend e.g. on how well the test sample follows the rules that the training data followed and that were learned by the autoencoder in the process of being trained. Thus in many convenient embodiments, an autoencoder may be “trained” on training data (in which training process any reconstruction error is minimized, as discussed later herein); the resulting trained autoencoder may be used to encode test data in order for the test data to be analyzed in any of a variety of ways, also as discussed later herein.

In short, an autoencoder allows each individual sample of an original data set to be represented as a set of values from which the original sample can be reconstructed with a set of learned functions. The use of an autoencoder can thus provide data in a form in which analysis, e.g. pattern recognition, may be able to be performed far more efficiently and/or quickly than with the data in its original, uncompressed form.

An autoencoder may be used for the purposes herein, in one of e.g. two general approaches. In a first general approach, test data is encoded by the autoencoder (pre-trained on training data) and the encoded data is subjected to a multidimensional cluster analysis. In such an analysis, a set of test data is encoded by an autoencoder to produce a number of representative values. (Typically, the autoencoder will have been pre-trained e.g. on a separate, training data set, in the general manner described in the Reconstruction-based analysis section below and in the Working Examples herein.) The representative values for the individual data samples of the test data set are then evaluated to determine whether they can be clustered into groups. Values that appear to fall outside clusters may then be flagged as potentially anomalous.

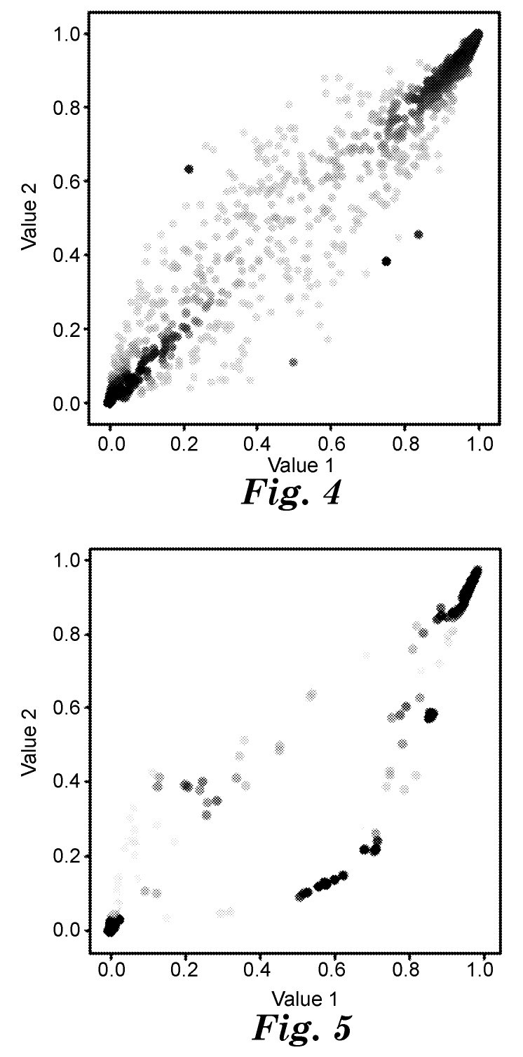

By way of an illustrative example, FIGS. 4 and 5 depict numerous encoded test data samples (obtained from use of actual sensing units mounted on HVAC air filters in the field) for two different air filters installed in two different HVAC systems. The original, unreduced test data behind FIGS. 4 and 5 was a set of two-hour time-temperature-pressure (t/T/P) data samples of the general type shown in FIG. 3. (Here and elsewhere herein, a time-temperature and/or time-pressure waveform (e.g. a two-hour waveform) will generally be referred to as a data “sample”, multiple such data samples will generally be referred to as a data “set” or data “population”.) The representative values were obtained by using a pre-trained autoencoder to dimensionally reduce the test data samples as described in the Working Examples.

FIGS. 4 and 5 thus depict encoded test data for a large number (estimated to be at least several thousand) of samples (two-hour waveforms) obtained over several months of functioning of the respective HVAC systems. FIGS. 4 and 5 depict the result of reducing each original test data sample to two representative values (that is, performing a two-dimensional cluster analysis). FIGS. 4 and 5 are thus density plots with the magnitude (darkness) of each circle being indicative of the number of individual data samples that were reduced to that particular combination of representative values.

For the HVAC system of FIG. 4, the dimensionally-reduced test data samples fell into a broadly consistent pattern that exhibited two distinct clusters. A possible interpretation of these clusters is that one generally corresponds to a temperature-control unit being “on” and the other corresponds to the temperature-control unit being “off”. However, it is emphasized that a useful attribute of autoencoder-based methods is that it is not required that the particular factors behind the behavior must be known in order to carry out the analysis.

In contrast, for the HVAC system of FIG. 5, the dimensionally-reduced test data samples did not appear to fall into a broadly consistent pattern and, in particular, did not appear to exhibit two distinct clusters in the manner of FIG. 4. A result of the type exemplified by FIG. 5 may cause the processing unit to conclude that anomalous behavior has been exhibited and may thus prompt the processing unit to issue an indication that the temperature-control unit of the particular HVAC system in question should be considered e.g. for an evaluation or service call.

As a check, a small number of anomalous-appearing data samples from the encoded test data of FIG. 5 were selected and the original time-temperature-pressure (t/T/P) data samples (waveforms) that corresponded to these encoded data samples were retrieved. Inspection of the original test samples indicated that anomalous behavior indeed appeared to be present, e.g. pressure fluctuations at a time that, according to the temperature data, no heating was occurring. This thus provided evidence of the efficacy of the cluster analysis. It is also noted that it would be unwieldy to scan large numbers of unreduced time-temperature-pressure data samples in order to identify cases of such anomalous behavior (absent any guidance provided by the autoencoded data as described above), thus again attesting to the usefulness of dimensional reduction of data.

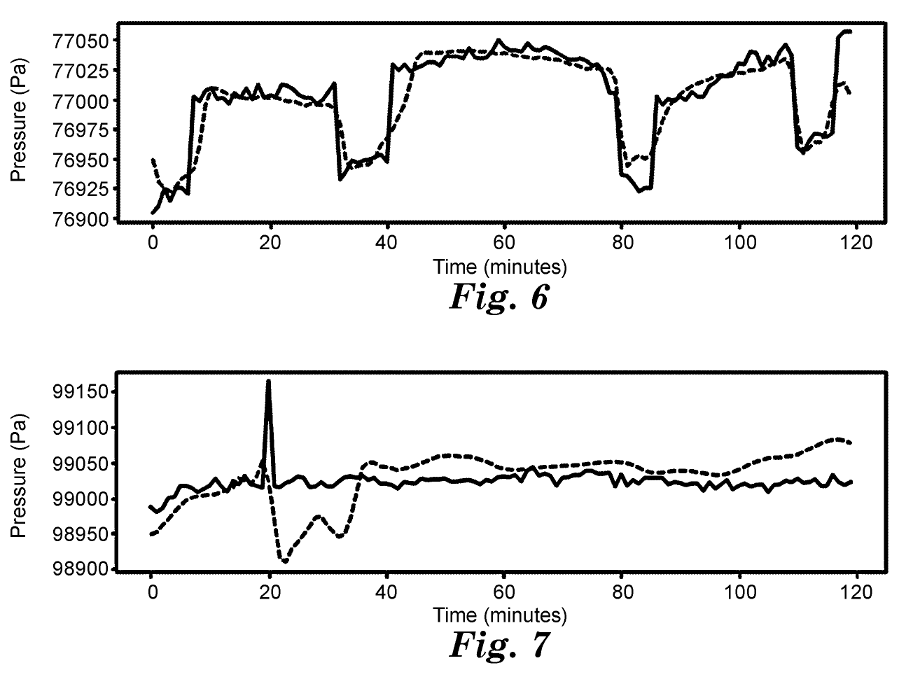

It will be understood that FIGS. 5 and 6 are examples in which test data samples were encoded to reduce them to two representative values and in which the data for these two particular HVAC systems exhibited differences that were readily apparent when the representative values were displayed in a two-dimensional plot in the manner of FIGS. 5 and 6. The reduction of this test data down to two representative values was done for the purpose of displaying the results of a cluster analysis in a form (i.e. in a two-dimensional plot) that can be readily visualized. It is emphasized that a cluster analysis may be run on data that has been dimensionally reduced to any number of representative values (e.g., 3, 5, 10, or more) even if the results cannot be readily visualized e.g. on a 2D plot. (Typically, an autoencoder may perform encoding until dimensional reduction has been performed down to the smallest number of representative values that allow the original data sample to be reconstructed to a specified accuracy.)

The criteria (e.g. quantitative standard or threshold) that is used to determine whether any particular dimensionally-reduced data sample is considered to be potentially anomalous, can be chosen as desired, e.g. in consideration of the particular data regime in question. In various embodiments, such criteria may be established by the administrator of the monitoring system and/or the monitoring system may be configured with the ability to revise or fine-tune such criteria as more and more data is accumulated. In some embodiments, a user may be able to affect such criteria. That is, in some instances a user may be able to input whether to use a very tight criteria or a very forgiving criteria in terms of identifying possibly anomalous data points. (The data of FIGS. 4 and 5 were not subjected to any particular quantitative evaluation or criteria; rather, these data were selected as appearing to show differences that were readily apparent upon visual inspection, for purposes of illustration.)

The cluster-analysis-based approach described above does not necessarily require that an encoded test data sample (or a set of encoded test data samples) must be decoded (reconstructed) in order to determine whether anomalous behavior appears to be present. In a second general approach using a trained autoencoder, a specific test sample is fully encoded and then reconstructed, and any differences between the original test sample and the reconstructed test sample are ascertained in order to determine whether anomalous behavior appears to be present.

In a reconstruction-based analysis of a test sample, an autoencoder that has been pre-trained on training data as described above may be used to evaluate any desired test data by subjecting the test data to an encoding-followed-by-decoding analysis. That is, the reconstruction error that arises in reconstructing a particular test sample from the set of representative values to which that test sample was reduced by encoding, may be evaluated. Thus in an evaluation phase of a reconstruction-based analysis, a reconstruction process may be performed on an encoded test sample with the degree of deviation between the reconstructed test sample and the original test sample providing a diagnostic indicator.

The degree of closeness or disparity between an original test sample and the reconstructed test sample may provide a measure of how well the test sample conforms to the behavior of the training data on which the autoencoder was trained. For some test samples, the reconstructed data sample may closely match the original input test sample, as in the exemplary plot (in which the temporal variable is pressure and in which the original sample is in solid lines and the reconstructed sample is in dashed lines) of FIG. 6. For other test data samples, the reconstructed data sample may exhibit significant deviations from the original sample, as shown in the exemplary plot of FIG. 7.

FIGS. 6 and 7 are representative results selected from test data that was estimated to include over 20000 two-hour time-temperature-pressure data samples. The reconstructed data samples of FIGS. 6 and 7 were taken from data obtained in the field for actual HVAC systems with both being analyzed using an autoencoder that had been trained using the same training data. The training data was also obtained in the field and was estimated to have included at least 100000 two-hour time/pressure/temperature samples of pressure and temperature (obtained from over 100 HVAC systems over a period of approximately three months).

FIG. 6 shows a reconstructed two-hour time-pressure test sample for one HVAC system; FIG. 7 shows a similarly reconstructed test sample for a different HVAC system. Each reconstructed data sample (waveform) is shown in comparison to the original data waveform. In both cases, two temporal parameters (pressure and temperature) were obtained and subjected to analysis. That is, although only one of the parameters (pressure) is reproduced in FIGS. 6 and 7, in the autoencoding analysis pressure and temperature were co-analyzed (as a function of time) in combination. This allowed the analysis to take into account relationships between the two parameters and enhanced the ability of the analysis to identify patterns in the data versus, for example, examining one parameter alone or examining each parameters independently of the other.

A result of the general type exemplified by FIG. 6 indicates that the test sample seems to follow the same general “rules” as the training data. In other words, no anomalous behavior in the test sample (in the sense of differing appreciably from the behavior of the training data) is readily apparent. In contrast, a result of the general type exemplified by FIG. 7 indicates that this test sample does not seem to follow the same “rules” as the training data. In other words, such a result indicates that the HVAC system as represented by FIG. 7 is not behaving in the same manner as the HVAC system(s) of the training data, thus raising the possibility that an issue may exist e.g. with the temperature-control unit in that particular HVAC system.

Although not presented in the Figures herein, a similar results were found when temperature data was reconstructed. That is, for the HVAC system of FIG. 6, the reconstructed temperature test data plot matched the original data plot rather well, whereas anomalous behavior seemed to be present in the temperature data for the HVAC system of FIG. 7.

The criteria (e.g. quantitative standard or threshold) that is used to determine whether any particular deviation between reconstructed data and original input data will cause a data point to be considered to be potentially anomalous, can be chosen as desired, e.g. in similar manner to criteria used in a cluster analysis as discussed above.

In some embodiments, the training data used in an autoencoding-based analysis may be a data set (population) that includes numerous data samples (e.g. two-hour time-temperature-pressure waveforms) obtained from many HVAC systems, e.g. systems considered to be well-behaving. The behavior of any particular HVAC system can thus be compared to the behavior of a (nominally) well-behaving population of HVAC systems. In such a population-based analysis, sufficient deviation in the behavior of a particular HVAC system from that of the training population may indicate an issue with that HVAC system.

In some embodiments the training data may include historical data samples (e.g. two-hour time-temperature-pressure waveforms) for a particular HVAC system, to which a new data sample for that particular HVAC system is to be compared. In other words, the current behavior of an HVAC system can be compared to the historical behavior of that same HVAC system and any deviation from historical performance may indicate that an issue has arisen with the HVAC system. In more general terms, the behavior of an HVAC system at any time may be compared to its behavior at other times, in order that, for example, an intermittent problem may be revealed. In various embodiments an autoencoding-based analysis may comprise a population-based analysis, a historical analysis, or some combination of both.

The arrangements disclosed herein advantageously allow a large data set to be collected (e.g. from data that may already be being gathered for some other purpose) and brought to bear on the analysis of any individual test sample. Regardless of whether such an approach involves e.g. multidimensional cluster analysis of test data or reconstruction of test data, such arrangements allow the behavior of a particular HVAC system during a particular time period to be analyzed as a part of a large population of data, rather than being analyzed as a stand-alone, individual data sample. It will be appreciated that such methods may allow more subtle behaviors and/or conditions of the HVAC system to be identified.

Many variations, modifications and enhancements of the above-presented arrangements may be performed. For example, the discussions above have concerned the use of training data chosen without regard to any specific factors. That is, such training data would likely include time periods (e.g. the two-hour time segments described above) during which the HVAC system was working under very different conditions. That is, some time periods may have occurred while the temperature-control unit was holding at a high (e.g. daytime) set point, some may have occurred while the temperature-control unit was holding at a low (e.g. nighttime) set point, some may occurred while the temperature-control unit was transitioning from a low to high set point or vice versa, and so on. And, of course, data may be taken for many different HVAC systems in many different types of dwellings in many different geographic locations. Nevertheless, such a training set can enable a useful analysis as demonstrated herein.

However, in some embodiments the training data may be refined in any of a variety of ways. For example, training data may be used that corresponds to a particular mode of operation (e.g. constant heating or cooling to a particular set point, transition between set points, etc.), to a particular type or model of temperature-control unit, to a particular size or type of dwelling (e.g. two-story versus ranch), and so on. As data is made available from a larger and larger number of HVAC systems operating under various circumstances, training data can be used that is more and more finely parsed. Thus, for any given HVAC system or operating condition the behavior of the system can be analyzed by the use of training data that is chosen as optimal for analysis of that particular system.

Furthermore, a processing unit as disclosed herein may be capable of self-learning to at least an extent. For example, an initial set of training data may include at least some entries that, as a result of the analysis, seem to exhibit anomalous behavior. Such entries may then be deleted from the data set and training performed again, to arrive at a more refined set of training data. This may then allow more subtle behavioral trends or differences, that may not have been identifiable in an analysis based on the original training data, to be uncovered in certain HVAC systems. Conversely, the processing unit may, with continued training, recognize certain potentially anomalous behaviors as being false positives and may cease to regard such behaviors as anomalous. In some embodiments the processing unit may be trained e.g. to recognize that a particular HVAC system comprises a variable speed fan and to compensate or otherwise allow for such phenomena as needed.

In some embodiments the processing unit of the monitoring system may use additional data that is not derived from the HVAC system, to enhance the analysis. For example, it can use weather data for the geographic area in which the HVAC system is located, obtained e.g. using arrangements of the type disclosed in U.S. Patent Application Publication 2017/0361259, which is incorporated by reference in its entirety herein for this purpose. In some embodiments such weather data may include the ambient temperature in the area, so that the operation of the HVAC system as a function of the ambient temperature can be monitored.

In some embodiments the monitoring system may allow a user to input into the processing unit (e.g. through an app), the actual day/time/temperature set-point schedule of the thermostat that controls the temperature-control unit. This can allow the operation of an HVAC system to be monitored as a function of the actual temperature set-point schedule of the system, which may further enhance the ability of the monitoring system to detect anomalous behavior of the HVAC system. In some embodiments, the set-point schedule and the local weather conditions (e.g. ambient temperature) may be used in combination. To take a simple but illustrative example, the monitoring system may be configured to issue a report of anomalous behavior if a temperature-control unit (e.g. a heating unit controlled to a set-point of e.g. 65 degrees) has not run for two days during which the outside temperature averaged 10 degrees F; however, the system may not flag this as being anomalous behavior if the outside temperature averaged 70 degrees F during this time.

It will further be appreciated that as more and more data from the field becomes available, the analytical methods relied on by the processing unit may be further enhanced still further. For example, it may become apparent that particular problems with certain temperature-control units may be manifested as particular modes of behavior (whether in unreduced data or in autoencoded data). The administrator of the monitoring system may, if desired, augment the system to enhance the ability of the system to detect any such particular signatures of a possible problem.

In a related topic, in some embodiments the monitoring system may be configured to provide a report that is a generic indication of a possible problem or issue with an HVAC system. In other embodiments, the monitoring system may be configured to provide a report that includes an indication of a specific problem that may be among the more likely possible causes of the observed behavior. Again, as ever-larger populations of HVAC systems are monitored, feedback may be generated that allows the sensitivity and sophistication of the analyses, and/or the reports that are generated, to be enhanced.

Given sufficient data and/or training of the processing unit, it may be possible for the systems and methods disclosed herein to identify patterns in the data that appear to be signatures of particular behaviors that may be problematic. Such behavior may include, but is not limited to, erratic on/off behavior of a blower fan, erratic on/off behavior of a burner, very short or very long on/off cycles of the temperature-control unit, a very long period of time during which an draft-inducer blower of the temperature-control unit runs without the burner igniting, and/or failure of a blower fan to run for a sufficient time after flame-off. Underlying sources of such behavior may include, but are not limited to, a failing blower motor, a dirty flame sensor, a failing draft-inducer blower motor, a faulty thermostat, a faulty ignitor, an extinguished pilot light, a slipping blower belt, worn blower bearings, an interruption in a fuel supply, a faulty or failing limit switch, and/or dirty or frozen evaporator coils. Those of ordinary skill in the area of HVAC maintenance and servicing will appreciate that many other issues and behaviors may exist under various circumstances. It will be appreciated that the arrangements disclosed herein may make it possible to spot and/or diagnose problems that are intermittent rather than ongoing. As will be well understood, such problems may often be difficult to identify.

An anomalous behavior does not necessarily have result from, or indicate the possibility of, a problem that may cause the temperature-control unit to fail. For example, an analysis may indicate that a temperature-control unit is short-cycling in a manner that suggests that the dip switches (e.g. of an older thermostat) are set in a configuration that causes the temperature-control unit to short-cycle. Such behavior may merely indicate that the temperature-control unit is not operating as efficiently as it might. Moreover, from analyzing the data the processing unit may be able to distinguish between such an occurrence and a case in which a temperature-control unit is short-cycling because the unit is overheating and tripping its limit switch, which may be a more urgent issue. In another simple but illustrative example, the monitoring system may recognize, and be able to inform a user, that the clock of a programmable thermostat has not yet been reset to daylight savings time or standard time.

As noted, in various embodiments the herein-disclosed monitoring system may actively issue a “push” notification or may passively collect information to be provided to a user on-demand. In some embodiments, a user may be allowed to designate some behaviors and/or possible causes as being worthy of an active notification with other behaviors being designated as less potentially urgent and thus being only passively collected and made available upon request.

From the discussions herein it will be appreciated that the monitoring system may be configured to, in various circumstances, issue a notification that may range e.g. from very general to very specific. For example, a user may be notified that the HVAC system seems to be exhibiting anomalous behavior; and/or, the user may be notified that the temperature-control unit seems to be exhibiting anomalously long flame-up times; and/or, the user may be notified that the draft-inducer blower motor may possibly be malfunctioning. (It will be understood that these are merely examples of possible notifications, chosen for illustration.)

The arrangements disclosed herein can allow a monitoring system that is ostensibly provided for one specific purpose (e.g. to monitor the remaining usable life of an air filter) to be leveraged for an entirely different purpose (e.g. to monitor the condition of a temperature-control unit of an HVAC system and to report any potential issues therewith). In other words, the monitoring system may mine the same data stream in a way that can extract additional, useful information from the data.

Use of the arrangements disclosed herein may, for example, reduce or eliminate the need for a relatively expensive or complicated stand-alone monitoring system. To take a simple example, a monitoring system as disclosed herein may allow a user to receive reports that indicate whether an HVAC system is operating properly when the user is away from the dwelling for an extended period of time (e.g. is on vacation), without the user needing to install a “smart” or internet-connected thermostat or temperature-control unit or an intelligent personal digital assistant service or home automation hub with hardware that is equipped with a temperature sensor. (However, a sensing unit as disclosed herein may be configured to communicate with any such service, hub or the like, if desired).

It will be appreciated that even if a monitoring system as disclosed herein only provides a user with a few days, or even a few hours, notice that, for example, a temperature-control unit of an HVAC may be about to fail, such advance warning may be exceeding useful e.g. in sub-zero climates where the unexpected failure of an HVAC system can have serious consequences. That is, even a small amount of notice that allows a service call to be made before an HVAC system becomes inoperative, may be extremely useful. As noted earlier herein, temperature-control units of HVAC systems are often in relatively remote locations of building units and tend to go unvisited and unnoticed by dwelling occupants for long periods of time. The arrangements disclosed herein may assist in identifying potential issues that may otherwise go unnoticed until a serious problem develops. It will be understood that the use of a monitoring system as disclosed herein will be as an adjunct to existing practices, to enhance the ability of a user to monitor an HVAC system. Use of such a monitoring system may thus be a useful addition to existing practices and does not relieve the user of the responsibility to maintain the HVAC system, have it serviced regularly, and so on.

Discussions herein have primarily concerned processing data to obtain information concerning the state of a temperature-control unit of an HVAC system. However, it will be appreciated that in a more general sense the arrangements disclosed herein may, in at least some embodiments, be able to provide information concerning other, e.g. system-wide, attributes of the HVAC system. Such attributes may e.g. adversely affect the efficient functioning of the temperature-control unit of the HVAC system. For example it may be possible for the monitoring system to diagnose a situation in which so many registers/outlets of the HVAC system have been closed that the system is “choked” and operating inefficiently. It is thus noted that in some embodiments, the systems and methods disclosed herein may be used to obtain an indication of the condition of an HVAC system and to report the condition of the HVAC system, rather than being limited to obtaining and reporting an indication the condition of the temperature-control unit of the HVAC system. It is emphasized that merely monitoring the condition of an air filter in order to e.g. report an estimate of the remaining usable life of the filter for e.g. particle filtration, will not be considered to constitute processing data to obtain an indication of the condition of an HVAC system and/or reporting the condition of the HVAC system in the manner disclosed herein, unless the monitoring system is purposefully configured to perform this function.

It is further noted that while discussions herein have primarily concerned using a processing unit that is a remote processing unit, in some embodiments a processing unit may be located on-board the sensing unit. In some such embodiments, the sensing unit need not necessarily transmit the data to a remote entity for processing but rather may perform all necessary processing on-board. In some such embodiments the sensing unit may wirelessly transmit an indication of the condition of the HVAC system (e.g. of a temperature-control unit thereof) e.g. to a mobile device or a cloud-based server in order that a condition report can be conveyed to a user therefrom. In some embodiments, a sensing unit may be self-contained even to the point of issuing a condition report to a user (e.g. as an audible or visual signal).

### Exemplary embodiments

The disclosures presented herein include, but are not limited to, the following exemplary embodiments, arrangements and combinations.

Embodiment 1 is a system for monitoring the condition of an air filter installed in an HVAC system of a building unit and for monitoring the condition of a temperature-control unit of the HVAC system, the monitoring system comprising: a single, filter-mounted sensing unit configured to acquire data representative of at least a first temporal parameter of the HVAC system and to wirelessly transmit the data, and, a remote processing unit configured to receive the data and to process the data to obtain an indication of the condition of the air filter and to report the condition of the air filter, wherein the remote processing unit is also configured to process the data to obtain an indication of the condition of the temperature-control unit of the HVAC system and to report the condition of the temperature-control unit.

Embodiment 2 is the system of embodiment 1 wherein the data includes data representative of a first temporal parameter of the HVAC system and data representative of a second temporal parameter of the HVAC system. Embodiment 3 is the system of embodiment 2 wherein the first temporal parameter is pressure, and the second temporal parameter is temperature. Embodiment 4 is the system of any of embodiments 2-3 wherein the processing unit is configured to co-analyze the data representative of the first temporal parameter and the data representative of the second temporal parameter. Embodiment 5 is the system of any of embodiments 1-4 wherein the remote processing unit is configured so that processing the data to obtain an indication of the condition of the temperature-control unit of the HVAC system comprises performing a pattern recognition operation on the data with the data in unreduced form.

Embodiment 6 is the system of any of embodiments 1-4 wherein the remote processing unit is configured so that processing the data to obtain an indication of the condition of the temperature-control unit of the HVAC system comprises dimensionally reducing the data. Embodiment 7 is the system of embodiment 6 wherein the remote processing unit is configured so that processing the data further comprises performing a pattern recognition operation on the dimensionally reduced data. Embodiment 8 is the system of any of embodiments 6-7 wherein the remote processing unit comprises an autoencoder that performs the dimensional reduction of the data. Embodiment 9 is the system of embodiment 8 wherein the remote processing unit is configured so that the pattern recognition operation performed on the dimensionally reduced data comprises performing a multidimensional cluster analysis on the dimensionally reduced data. Embodiment 10 is the system of embodiment 9 wherein the multidimensional cluster analysis is performed on a population of test data that includes the data from the HVAC system, and that is performed using an autoencoder that was pre-trained on a population of training data. Embodiment 11 is the system of embodiment 6 wherein the remote processing unit comprises a pre-trained autoencoder that dimensionally reduces the data and wherein the remote processing unit is further configured to reconstruct the dimensionally reduced data; and, wherein the remote processing unit is configured to evaluate any reconstruction error that arises in reconstructing the dimensionally reduced data.

Embodiment 12 is the system of any of embodiments 1-11 wherein the remote processing unit is configured to report the condition of the temperature-control unit by sending a push notification. Embodiment 13 is the system of any of embodiments 1-11 wherein the remote processing unit is configured to report the condition of the temperature-control unit by providing a condition report upon request by a user. Embodiment 14 is the system of any of embodiments 1-13 wherein the remote processing unit is resident on a cloud-based server and wherein the system comprises an app that is resident on a mobile device and that enables the mobile device to wirelessly receive the data from the sensing unit and to forward the data to the cloud-based server. Embodiment 15 is the system of embodiment 14 wherein a report on the condition of the temperature-control unit that is generated by the remote processing unit is transmitted to the mobile device and presented to a user of the mobile device by the app. Embodiment 16 is the system of any of embodiments 1-15 wherein the remote processing unit is further configured to obtain and use weather data, from a source other than the sensing unit, for the geographic area in which the HVAC system is located, in obtaining the indication of the condition of the temperature-control unit of the HVAC system.

Embodiment 17 is a system for monitoring the condition of an air filter installed in an HVAC system of a building unit and for monitoring the condition of the HVAC system, the monitoring system comprising: a single sensing unit configured to acquire data representative of at least a first temporal parameter of the HVAC system, and, a processing unit configured to receive the data and to process the data to obtain an indication of the condition of the air filter and to report the condition of the air filter, wherein the processing unit is also configured to process the data to obtain an indication of the condition of the HVAC system and to report the condition of the HVAC system.

Embodiment 18 is a method of monitoring the condition of an air filter installed in an HVAC system of a building unit and of monitoring the condition of the HVAC system, the method comprising: processing data that is representative of at least a first temporal parameter of the HVAC system and that is obtained by a single sensing unit that located downstream of the air filter, to obtain an indication of the condition of the air filter, and reporting the condition of the air filter to a user; and, processing the data to obtain an indication of the condition of the HVAC system, and reporting the condition of the HVAC system to a user. Embodiment 19 is the method of claim 18 wherein the indication of the condition of the HVAC system is an indication of the condition of a temperature-control unit of the HVAC system. Embodiment 20 is the method of any of embodiments 18-19 wherein the single sensing unit is mounted on the air filter. Embodiment 21 is the method of any of embodiments 18-20 wherein the data is processed by a remote processing unit that wirelessly receives the data from the single sensing unit.

### Examples

### Hardware and Background

Sensing units were produced of the general type disclosed in U.S. Patent 10,363,509, which is incorporated by reference in its entirety herein. The sensing units each comprised a pressure sensor, a temperature sensor, and a Bluetooth Low Energy radio transmitter/receiver operating at approximately 2.4 GHz. Each sensing unit was mounted on the downstream face of an air filter of the general type available from 3M Company, St. Paul, MN, under the trade designation Filtrete (e.g., Filtrete Air Filter MPR (Microparticle Performance Rating) 1500), to form an assembly of the general type available from 3M Company under the trade designation Filtrete Smart Air Filter 1500. The sensing units were set up to obtain temperature and pressure data once per minute and to store the data on-board until wirelessly transmitted.

These sensing-unit-equipped air filters were distributed in open sales. An app was made available (under the trade designation FILTRETE SMART) that enabled a mobile device (e.g. smartphone) on which the app was resident to communicate with the sensing units, to wirelessly receive data from the sensing units, and to forward the data to a cloud-based server. A processing unit resident on the cloud-based server processed the data and returned an indication of the filter condition to the app. The app could then display a report or notification of the filter condition. Several thousand such filters and sensors were distributed over a period of several months and were used in this manner. A very large data population was thus collected, for a wide variety of geographical locations, dwelling types, HVAC configurations, types of temperature-control units, and so on.

### Data for analysis

Time-temperature-pressure data from the above-described data population was obtained (in anonymized form) for analysis. The data was subdivided into two-hour time periods (with the temperature and pressure being measured once per minute as noted). Each such two-hour time-temperature-pressure (t/T/P) waveform thus corresponds to a data “sample” as described herein. Multiple such two-hour data samples (greater than 100,000) were obtained, for multiple sensing units, covering several months time and encompassing HVAC systems of a wide variety of types, located in a variety of buildings and geographic areas. FIG. 3 presents a representative sample of time-temperature-pressure data obtained for a particular HVAC unit over a particular two-hour time period.

### Autoencoding/cluster analysis

A large set (estimated to be greater than 80000) of the above-described time-temperature-pressure (t/T/P) data samples was used as training data to train an autoencoder to perform dimensional reduction and to arrive at representative values in the general manner described earlier herein. The training data was autoencoded using custom-built architectures written using publicly available software libraries.

A somewhat smaller set (estimated to be approximately 20000 t/T/P samples, with no overlap with the above-described training population) of the above-described data samples was used as test data and was encoded and subjected to cluster analysis using the autoencoder that had been trained as described above.

FIG. 4 presents the result of encoding numerous data samples for a single representative sensing unit, air filter and HVAC system. In this instance the encoded test data samples were subjected to a multidimensional cluster analysis in which the test data samples, each as reduced to two representative values, were presented on a two-dimensional plot as shown in FIG. 4. FIG. 4 is a density plot with each circle signifying one or more individual t/T/P test samples, with the number of data samples represented by each circle being indicated by the darkness of the circle. FIG. 5 presents similarly-analyzed data for a different sensing unit, air filter and HVAC system. The ramifications of these results are discussed elsewhere herein.

### Autoencoding/reconstruction analysis

A large set (estimated to be greater than 80000) of the above-described (t/T/P) data samples was used as training data to train an autoencoder to perform dimensional reduction and to arrive at representative values in the general manner described earlier herein.

A somewhat smaller set (estimated to be approximately 20000 t/T/P samples, with no overlap with the above-described training population) of the above-described data samples was then used as test data. In this analysis, particular individual t/T/P samples from the test data set were encoded in like manner as for the training data. For each individual test data sample, the resulting representative values were then input to the decoder network to reconstruct time-pressure and time-temperature data samples which were compared to the original time-pressure and time-temperature data samples.

The results of such a time-pressure reconstruction for one two-hour test sample for a particular sensing unit/HVAC system is shown in FIG. 6 (with original test data in solid lines and reconstructed data in dashed lines). The results of a similar analysis for a two-hour test sample for a different sensing unit/HVAC system is shown in FIG. 7. (In both cases, only pressure data is shown although the pressure and temperature data were co-analyzed as discussed earlier herein.) The ramifications of these results are discussed elsewhere herein.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

What is claimed is:

1. A system for monitoring the condition of an air filter installed in an HVAC system of a building unit and for monitoring the condition of a temperature-control unit of the HVAC system, the monitoring system comprising:
a single, filter-mounted sensing unit configured to acquire data representative of at least a first temporal parameter of the HVAC system and to wirelessly transmit the data,
and,
a remote processing unit configured to receive the data and to process the data to obtain an indication of the condition of the air filter and to report the condition of the air filter,
wherein the remote processing unit is also configured to process the data to obtain an indication of the condition of the temperature-control unit of the HVAC system and to report the condition of the temperature-control unit.

2. The system of claim 1 wherein the data includes data representative of a first temporal parameter of the HVAC system and data representative of a second temporal parameter of the HVAC system.

3. The system of claim 2 wherein the first temporal parameter is pressure and the second temporal parameter is temperature.

4. The system of claim 2 wherein the processing unit is configured to co-analyze the data representative of the first temporal parameter and the data representative of the second temporal parameter.

5. The system of claim 1 wherein the remote processing unit is configured so that processing the data to obtain an indication of the condition of the temperature-control unit of the HVAC system comprises performing a pattern recognition operation on the data with the data in unreduced form.

6. The system of claim 1 wherein the remote processing unit is configured so that processing the data to obtain an indication of the condition of the temperature-control unit of the HVAC system comprises dimensionally reducing the data.

7. The system of claim 6 wherein the remote processing unit is configured so that processing the data further comprises performing a pattern recognition operation on the dimensionally reduced data.

8. The system of claim 7 wherein the remote processing unit comprises an autoencoder that performs the dimensional reduction of the data.

9. The system of claim 8 wherein the remote processing unit is configured so that the pattern recognition operation performed on the dimensionally reduced data comprises performing a multidimensional cluster analysis on the dimensionally reduced data.

10. The system of claim 9 wherein the multidimensional cluster analysis is performed on a population of test data that includes the data from the HVAC system, and that is performed using an autoencoder that was pre-trained on a population of training data.

11. The system of claim 6 wherein the remote processing unit comprises a pre-trained autoencoder that dimensionally reduces the data and wherein the remote processing unit is further configured to reconstruct the dimensionally reduced data; and, wherein the remote processing unit is configured to evaluate any reconstruction error that arises in reconstructing the dimensionally reduced data.

12. The system of claim 1 wherein the remote processing unit is configured to report the condition of the temperature-control unit by sending a push notification.

13. The system of claim 1 wherein the remote processing unit is configured to report the condition of the temperature-control unit by providing a condition report upon request by a user.

14. The system of claim 1 wherein the remote processing unit is resident on a cloud-based server and wherein the system comprises an app that is resident on a mobile device and that enables the mobile device to wirelessly receive the data from the sensing unit and to forward the data to the cloud-based server.

15. The system of claim 14 wherein a report on the condition of the temperature-control unit that is generated by the remote processing unit is transmitted to the mobile device and presented to a user of the mobile device by the app.

16. The system of claim 1 wherein the remote processing unit is further configured to obtain and use weather data, from a source other than the sensing unit, for the geographic area in which the HVAC system is located, in obtaining the indication of the condition of the temperature-control unit of the HVAC system.

17. A method of monitoring the condition of an air filter installed in an HVAC system of a building unit and of monitoring the condition of the HVAC system, the method comprising:
processing data that is representative of at least a first temporal parameter of the HVAC system and that is obtained by a single sensing unit that is located downstream of the air filter, to obtain an indication of the condition of the air filter, and
reporting the condition of the air filter to a user;
and,
processing the data to obtain an indication of the condition of the HVAC system, and
reporting the condition of the HVAC system to a user.

18. The method of claim 17 wherein the indication of the condition of the HVAC system is an indication of the condition of a temperature-control unit of the HVAC system.

19. The method of claim 17 wherein the single sensing unit is mounted on the air filter.

20. The method of claim 17 wherein the data is processed by a remote processing unit that wirelessly receives the data from the single sensing unit.
